(19) United States
(12) Patent Application Publication
(10) Pub. No.: US 2021/0269007 A1
(43) Pub. Date: Sep. 2, 2021

(54) Parking Brake Device for a Motor Vehicle

(71) Applicant: KNORR-BREMSE Systeme fuer Nutzfahrzeuge GmbH, Muenchen (DE)

(72) Inventors: Karsten SCHNITTGER, Muenchen (DE); Fabian GRIESSER, Muenchen (DE)

(21) Appl. No.: 17/253,982

(22) PCT Filed: Jun. 18, 2019
(86) PCT No.: PCT/EP2019/065933

§ 371 Date: Dec. 18, 2020

(30) Foreign Application Priority Data
Jun. 19, 2018 (DE) 10 2018 114 642.6

(51) Int. Cl. B60T 13/68; B60T 13/26

(52) U.S. Cl. CPC B60T 13/683; B60T 13/265

(57) ABSTRACT

A parking brake device for motor vehicles includes at least one compressed-air connection, an inlet venting-solenoid valve unit, a relay valve and at least one first compressed-air outlet. The compressed air connection is connected to the inlet venting-solenoid valve unit and the relay valve. A control line is mounted such that the relay valve is or can be connected to the inlet venting-solenoid valve unit, the control line having a first branch and a second branch upstream of the relay valve. An outlet line is provided that is connected to the at least one first compressed-air outlet and has an outlet branch. The parking brake device further has a spring brake line that is connected to the control line via the first branch and to the outlet line via the outlet branch, and a trailer valve line that is connected to the control line via the second branch. The parking brake device also has a spring brake valve that is arranged in the spring brake line and is connected to the relay valve, and a throttle unit that is arranged in the spring brake line between the outlet branch of the outlet line and the first branch of the control line.

### BACKGROUND AND SUMMARY OF THE INVENTION

The present invention relates to a parking brake device for motor vehicles, in particular a parking brake device having at least one compressed-air port, an inlet ventilation solenoid valve unit and a relay valve.

Parking brakes (also referred to as immobilizing brakes) of utility vehicles including trailers and rail vehicles are nowadays commonly equipped with spring-loaded brake cylinders which, in a release position, charge a spring compression chamber with compressed air and thus hold the spring under stress, whereas, for a parking braking action, the spring compression chamber is ventilated, that is to say connected to atmospheric pressure, such that the brake cylinder generates a braking force under the action of the spring (cf. Bosch, Automotive Handbook, 22nd edition, Dusseldorf, 1995, page 648).

WO 2015/154 787 A1 has already disclosed an electronic parking brake which utilizes a relay valve, the piston of which is designed as a stepped piston and exhibits feedback of the relay valve output to the control chamber of the relay valve. A restrictor unit is provided in the feedback path. However, a loss of compressed air arises, in particular during the ventilation of the device, owing to the feedback with the restrictor unit. A readjustment is required, wherein solenoid valves for aeration and ventilation must be correspondingly switched.

It is therefore the object of the present invention to advantageously further develop a parking brake device of the type mentioned in the introduction, in particular such that a parking brake device can be of relatively simple construction and can be aerated and ventilated in a relatively controlled manner.

The object is achieved according to the invention by means of a parking brake device having the features of the independent claim. According to the claim, a parking brake device for motor vehicles is provided, having at least one compressed-air port, an inlet ventilation solenoid valve unit, a relay valve and at least one first compressed-air output, wherein the compressed-air port is connected to the inlet ventilation solenoid valve unit and to the relay valve, wherein a control line is provided such that the relay valve is connected or connectable to the inlet ventilation solenoid valve unit, wherein the control line has a first branching point and a second branching point upstream of the relay valve, wherein an output line is provided which is connected to the at least one first compressed-air output and which has an output branching point.

It is provided here that a control valve is arranged between the first branching point and the second branching point of the control line.

It is explicitly disclosed that both a spring brake valve and a restrictor unit are provided in the spring brake line.

In particular, it may furthermore be provided that a spring brake line is provided which can be connected via the first branching point to the control line and via the output branching point to the output line.

Furthermore, a trailer valve line may be provided which is connected via the second branching point to the control line.

The parking brake device may in particular have a spring brake valve which is arranged in the spring brake line and is connected to the relay valve.

Furthermore, a restrictor unit may be provided, which is arranged in the spring brake line between the output branching point of the output line and the first branching point of the control line.

The spring brake valve and the restrictor unit are in particular connected to the relay valve via the spring brake line, the first branching point and the control line.

Furthermore, the spring brake line with the spring brake valve is connected via the control line to the inlet ventilation solenoid valve unit. In this way, it is possible for ventilation or aeration of at least one spring-loaded brake cylinder to be controlled, or shut off if necessary, in accordance with demand and in a highly accurate manner by means of the spring brake valve and the restrictor unit.

In the context of the present invention, it is preferably provided that the relay valve is in the form of a bistable element.

The relay valve preferably has an input, an output or working output, a control input and a ventilation output. The control line is connected via the control input to the relay valve. The compressed-air source is connected to the input of the relay valve. The output or working output of the relay valve is preferably connected or connectable via the output line to at least one spring-loaded brake cylinder.

A connection between the input and the output or working output of the relay valve is producible and controllable by virtue of a specific pressure being applied to the control input.

The specific pressure must be equal to or higher than a threshold pressure in order to be able to provide a connection between input and output. When the threshold pressure is attained, the ventilation output of the relay valve is closed.

A connection between the input and the output of the relay valve can be controlled in accordance with demand by means of fluid pressures which are at least equal to or higher than the predeterminable threshold pressure. In this way, it is advantageously possible to attain a specific pressure at the output or working output of the relay valve.

It may furthermore be provided that the spring brake line via the restrictor unit and the spring brake valve forms a feedback connection to the relay valve. In particular, the spring brake line via the spring brake valve and the restrictor unit forms a feedback between the output of the relay valve and the control input of the relay valve.

The spring brake line is preferably connected via the control line to the control input of the relay valve. Furthermore, the spring brake line is connected via the output line to the output or working output of the relay valve.

In particular, the restrictor unit may be arranged, along the spring brake line, between the first branching point and the spring brake valve.

Alternatively, the restrictor unit may be arranged, along the spring brake line, between the spring brake valve and the output branching point.

In this context, the restrictor unit is, in a manner dependent on the specific state or switching state of the parking brake device, provided upstream or downstream of the spring brake valve along the spring brake line.

Alternatively, the parking brake device may also be provided without a spring brake valve in the spring brake line. In this case, only the restrictor unit is arranged in the spring brake line which provides feedback. In particular, the spring brake valve may optionally be omitted, such that less-expensive parking brake devices with lower adjustment or actuation accuracy are also available if required.

In this context, by means of a combination of spring brake valve and restrictor unit in the spring brake line, it is possible in particular to avoid a loss of air during the course of a switching process between different operating modes of a motor vehicle with the parking brake device according to the invention. A switching process between the operating states can be performed more quickly, more efficiently and more precisely. In particular, through the prevention of a loss of air, no readjustment of compressed air is necessary.

As operating modes, a driving state, a parked state or a graduable braking state of the parking brake device may be provided for the motor vehicle.

For the graduable braking state, a demand-dependent constant pressure can be set at the output of the relay valve in order to attain any desired braking action.

In the context of the present invention, a constant pressure may be understood in particular also to mean a pressure range with a preferably predefinable maximum pressure and minimum pressure to be adhered to.

In particular, the pressure may lie between 0 bar and the maximum system pressure.

In the context of the present invention, a constant pressure or pressure range may in particular be set or held intermittently.

At the output of the relay valve, a pressure can be provided which is preferably proportional to the pressure at the control input of the relay valve.

Furthermore, a trailer test state may be provided, in which a braking action of the trailer is at least briefly eliminated in order to be able to check for a sufficient braking action of the tractor vehicle, in particular on a gradient.

Alternatively, it is furthermore possible for a stretch-brake state to be provided by means of the parking brake device according to the invention. It is thus possible, by means of a preferably graduable application of the brakes of the trailer, for the motor vehicle, with for example a tractor vehicle and a trailer, to be stretched, and can thus be stabilized.

Preferably, in this context, a parking brake and a service brake of the tractor vehicle are released in the stretch-brake state, wherein a service brake of the trailer is activated, in particular is activatable in graduable fashion.

In this context, a motor vehicle, in particular a utility vehicle, is to be understood preferably to mean a tractor vehicle with at least one trailer.

The switching between, for example, a driving state, a parked state or a graduable braking state can be performed more quickly and in a more controlled manner in particular by means of the parking brake device according to the invention.

It is furthermore possible for the spring brake valve to be provided as a solenoid valve which is open when electrically deenergized, such that, in the electrically deenergized state of the spring brake valve, between a control input and an output of the relay valve, there is feedback via the control line, the spring brake line and the output line with the spring brake valve and the restrictor unit.

In the electrically deenergized state, advantageous feedback between output and control input of the relay valve is provided, which feedback can be eliminated if required by switching of the spring brake valve. It is thus possible for a pressure from the output or working output of the relay valve to be usable as required for the control of the relay valve.

Furthermore, the spring brake valve may advantageously remain in the electrically deenergized open switching position during an operating state, and must merely be switched in order to change the operating state.

In particular, a connection between the input and the output of the relay valve can be obtained by virtue of the fact that the pressure at the output of the relay valve can be fed back to the control input of the relay valve.

A loss of air during the aeration and ventilation can be avoided at the output of the relay valve by means of the spring brake valve along the spring brake line. Switching between the operating states is performed more quickly, more efficiently and more precisely.

In the context of the present invention, valves are preferably provided as solenoid valves with a resetting spring. By means of electromagnetically switchable, spring-loaded valves, it is possible to ensure an electrically deenergized switching state at all times, in particular as soon as a switching state effected in a targeted manner, for example by electromagnetic switching, is ended.

It is furthermore possible for a constant pressure at the output of the relay valve or of the parking brake device to be controlled in open-loop and/or closed-loop fashion through switching of the spring brake valve.

This means that the inlet ventilation solenoid valve unit does not have to be switched in order to set a constant pressure at the output of the relay valve. The closed-loop control or setting of a constant pressure can be performed both more easily and more precisely by means of the spring brake line with the restrictor unit and the spring brake valve.

It may furthermore be provided that a control valve is arranged between the first branching point and the second branching point of the control line. It is thus possible for the pressure at the control input of the relay valve to be confined, while the pressure at the second branching point of the control line can be controlled in closed-loop fashion independently thereof.

By means of the control valve, various ports, which are controllable in closed-loop fashion independently of one another, are available on the control line, in the form of the first branching point, with the spring brake line, and the second branching point, with the trailer valve line.

It is furthermore possible for an inlet valve of the inlet ventilation solenoid valve unit to be provided as a solenoid valve which is open when electrically deenergized and for the control valve to be provided as a solenoid valve which is closed when electrically deenergized. By means of the control valve which is closed when electrically deenergized, the control input of the relay valve advantageously has a constant volume even if the line lengths to the trailer valve unit vary in different vehicle embodiments.

Preferably, a ventilation valve of the inlet ventilation solenoid valve unit is provided generally as a solenoid valve which is closed when electrically deenergized. In particular, the ventilation valve may be a 2/2 directional valve.

The spring brake valve is preferably provided as a solenoid valve which is open when electrically deenergized in the parking brake device according to the invention. The spring brake valve is preferably a 2/2 directional valve.

It is furthermore possible for the inlet valve of the inlet ventilation solenoid valve unit to be provided as a solenoid valve which is closed when electrically deenergized, and for the control valve to be provided as a solenoid valve which is open when electrically deenergized. By means of the inlet valve which is closed when electrically deenergized, it is advantageously also true in this case that the control input has a constant volume even if the line lengths to the trailer valve unit vary in different vehicle embodiments.

Furthermore, in this case, a trailer test state can be provided, wherein, proceeding from the parked state of the motor vehicle, a control module of the trailer is charged with compressed air via the trailer valve line and a trailer control output, connected thereto, of the parking brake device.

As a result of the pressurization with compressed air, the service brake of the trailer is released and imparts no braking action. In this context, the service brake of the trailer operates in an inverted manner in relation to a service brake of the tractor vehicle.

If the motor vehicle is parked on a gradient, the motor vehicle begins to roll as soon as the pressurization with compressed air is performed and the parking brake of the tractor vehicle cannot impart a braking force sufficient for parking the motor vehicle on the gradient. It is thus advantageously possible to detect in advance if the motor vehicle rolls away in the direction of the gradient in the event of failure of the service brake of the trailer.

It may furthermore be provided that the parking brake device has a trailer valve unit which is connected to the inlet ventilation solenoid valve unit via the trailer valve line, the second branching point and the control line.

It is thus possible, for example, for a control module for the actuation of the service brake of a trailer to be controlled in a monitored manner by means of a parking brake device according to the invention, in particular independently of at least one spring-loaded brake cylinder, as a parking brake of the tractor vehicle, and a service brake of the tractor vehicle.

It is furthermore possible for the trailer valve unit to be a trailer control valve which is connected to the spring brake line and via the spring brake line to the spring brake valve and the relay valve.

In this way, it is for example possible for a control module for the actuation of a service brake of a trailer to be controlled in an advantageous manner by means of the parking brake device according to the invention. In particular, a control module of the trailer can be actuated both via the trailer valve line with the inlet ventilation solenoid valve unit and via the spring brake line with the output of the relay valve.

Combined or independent control of the brake devices of the trailer and of the tractor vehicle is possible.

It is furthermore possible for the trailer valve unit to be formed as a trailer control module which is integrated into the parking brake device. By means of the integration of the trailer control module into the parking brake device, the volume of the control line to the trailer valve unit is always the same. Precise closed-loop control is advantageously made possible.

Furthermore, this allows the utilization of synergies between the parking brake device and the trailer valve unit. Through the common utilization of solenoid valves, it is possible, by comparison, to omit a total of two solenoid valves.

It may furthermore be provided that the inlet ventilation solenoid valve unit is designed such that at least one inlet valve is provided between the compressed-air port and the control line, and a ventilation valve is provided between the control line and a ventilation output. In this context, the ventilation solenoid valve may have the ventilation output.

The control line opens, upstream of the relay valve, into the preferably independent inlet valve and the independent ventilation valve within the inlet ventilation solenoid valve unit.

Alternatively, it may be provided that the inlet ventilation solenoid valve unit has a combined solenoid valve as inlet ventilation valve with the ventilation output. In this case, in the inlet ventilation solenoid valve unit, a holding valve is preferably provided between the combined inlet ventilation valve and the second branching point of the control line.

It is thus possible to achieve targeted controllability of the volumes within the parking brake device, in particular for the aeration and ventilation of the control input of the relay valve.

Further details and advantages of the invention will now be discussed on the basis of an exemplary embodiment which is illustrated in more detail in the drawings.

### BRIEF DESCRIPTION OF THE DRAWINGS

FIGS. 1a-f show a first exemplary embodiment of a parking brake device with a trailer control valve in different switching states;

FIGS. 2a-f show a second exemplary embodiment of a parking brake device with a trailer control valve in different switching states;

FIG. 3 shows a first exemplary embodiment of a parking brake device with an integrated trailer control module;

FIG. 4 shows a second exemplary embodiment of a parking brake device with an integrated trailer control module.

### DETAILED DESCRIPTION OF THE DRAWINGS

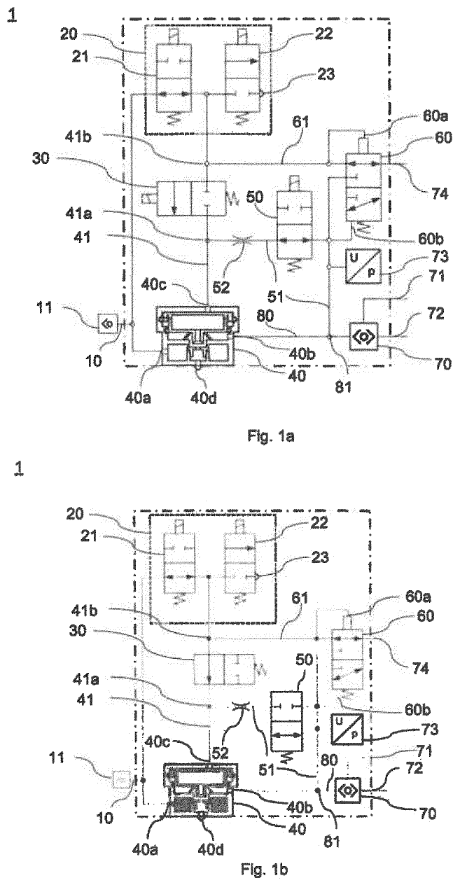

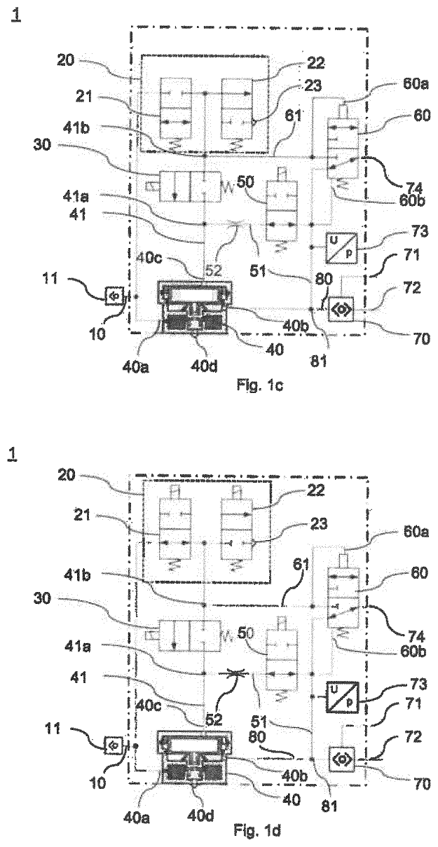

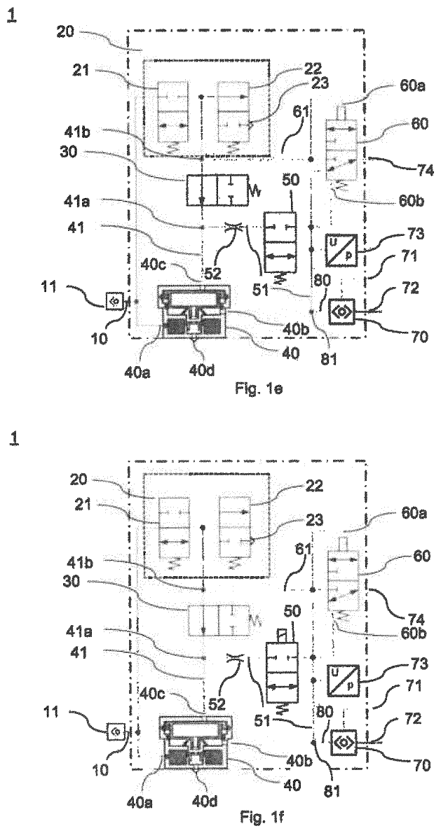

FIGS. 1a to 1f show, in a schematic illustration, a parking brake device 1 for motor vehicles, in this case of a utility vehicle, according to a first exemplary embodiment, in particular different switching states or operating states of the first exemplary embodiment.

As per FIG. 1a, the parking brake device has a compressed-air port 10, an inlet ventilation solenoid valve unit 20, and a relay valve 40.

The relay valve 40 is provided with an input 40a, with an output or working output 40b, a control input 40c and a ventilation output 40d. The compressed-air port 10 is connected to the input 40a of the relay valve 40.

The relay valve 40 constitutes a bistable element.

In a manner dependent on the pressure at the control input 40c, it is possible at the output 40b of the relay valve 40 to replicate different operating states of the parking brake device 1 in the form of air pressures, in particular a parked state, a driving state and a graduated braking state.

In particular, the first exemplary embodiment is illustrated in the parked state in FIG. 1a.

Furthermore, in the context of the first exemplary embodiment as per FIG. 1a, it is also possible for a stretch-brake state to be provided.

The inlet ventilation solenoid valve unit 20 is provided with an inlet valve 21 and a ventilation valve 22. As per FIG. 1a, the ventilation valve 22 has a ventilation output 23.

The inlet valve 21 and the ventilation valve 22 are provided as 2/2 directional valves.

The inlet valve 21 is configured to be closed when electrically deenergized. The ventilation valve 22 is configured to be closed when electrically deenergized.

The compressed-air port 10 is connected to the inlet input solenoid valve unit 20, in particular to the inlet valve 21.

The compressed-air port 10 is in this case represented by a compressed-air source (not illustrated in any more detail) and by a depicted check valve 11.

The parking brake device 1 is furthermore provided with a control line 41.

The control line 41 is connected to the inlet ventilation solenoid valve unit 20 such that the inlet valve 21 and the ventilation valve 22 are connected independently of one another to the control line.

The control line 41 is connected to the control input 40c of the relay valve 40. A connection is thus available between the inlet ventilation solenoid valve unit 20 and the control input 40c of the relay valve 40.

The control line 41 has, upstream of the relay valve 40, a first branching point 41a and a second branching point 41b.

A control valve 30 is provided in the control line 41 between the first branching point 41a and the second branching point 41b.

The control valve 30 is designed as a 2/2 directional valve. In the electrically deenergized state, the control valve 30 as per FIG. 1a is switched into an electrically deenergized open position.

Furthermore, the parking brake device 1 has a spring brake line 51. The spring brake line 51 is connected via the first branching point 41a to the control line 41.

There is thus a connection between the spring brake line 51 and the control input 40c of the relay valve 40.

Furthermore, the spring brake line 51 is connected via an output branching point 81 to an output line 80.

The output line 80 is connected to the output 40b of the relay valve 40, and likewise to at least one compressed-air output 71 and 72 of the parking brake unit 1.

Thus, the spring brake line 51 is connected via the output branching point 81 to the output or working output 40b of the relay valve 40. In this context, the spring brake line 51 forms a feedback connection between the output 40b and the control input 40c of the relay valve 40.

From the output 40b of the relay valve 40, compressed air can, as per FIG. 1a, be conducted along the output line 80 via a shuttle-type check valve 70 to a spring-loaded brake cylinder output 71 of the parking brake device 1 for the tractor vehicle of a motor vehicle.

The shuttle-type check valve 70 is connected via the output line 80 to the spring brake line 51, to the spring-loaded brake cylinder output 71 and to a service brake output 72 of the parking brake device for a tractor vehicle.

In this context, the spring-loaded brake cylinder output 71 and the service brake output 72 constitute compressed-air outputs of the parking brake unit 1.

With regard to its switching behavior, the shuttle-type check valve 70 follows the prevailing pressure gradient.

The shuttle-type check valve 70 is preferably provided as a so-called select-high valve.

It is thus possible for the spring-loaded brake cylinder output 71 to be aerated with a high pressure of the output 40b of the relay valve 40, wherein the connection to the service brake output 72, at which a relatively low pressure prevails, is blocked.

Furthermore, in the event of an actuation of the service brake and an associated pressure build-up at the service brake output 72, a transfer of compressed air from the service brake output 72 to the spring-loaded brake cylinder output 71 is possible via the shuttle-type check valve 70.

If a higher pressure prevails at the service brake output 72 than at the output 40b of the relay valve 40, the shuttle-type check valve 70 opens a connection between the service brake output 72 and the spring-loaded brake cylinder output 71, in accordance with the pressure gradient.

A combined braking action in the event of actuation of the service brake of the tractor vehicle at the service brake output 72 in combination with at least one spring-loaded brake cylinder of the tractor vehicle at the spring-loaded brake cylinder output 71 can be attained by means of the shuttle-type check valve 70.

Furthermore, a spring brake valve 50 is arranged in the spring brake line 51. Thus, the spring brake valve 50 is connected to the control input 40c and to the output 40b of the relay valve 40.

The spring brake valve 50 is switched into the electrically deenergized open state.

In FIG. 1a, the spring brake valve 50 is provided as a 2/2 directional valve.

A restrictor unit 52 is arranged in the spring brake line 51 between the output branching point 81 of the output line 80 and the first branching point 41a of the control line 41, in particular between the spring brake valve 50 and the first branching point 41a of the control line 41.

In general, in the context of the present invention, it is preferably always provided that the restrictor unit 52 and the spring brake valve 50 are arranged along the spring brake line 51 between the first branching point 41a of the control line 41 and the output branching point 81 of the output line 80.

A connection of the relay valve 40, in particular of the output 40b, and of the shuttle-type check valve 70, in particular of the service brake output 72 and/or of the spring-loaded brake cylinder output 71 as compressed-air outputs, to the control line 41 along the output line 80 and the spring brake line 51 is controllable by means of the spring brake valve 50 and the restrictor unit 52.

By means of the spring brake line 51, which provides feedback and which has the restrictor unit 52 and the spring brake valve 50, the fluid pressure or air pressure at the output 40b of the relay valve 40 can be targetedly set and controlled in open-loop and/or closed-loop fashion.

A compressed-air sensor 73 is furthermore arranged between the spring brake valve 50 and the output 40b of the relay valve 40. The air pressure or fluid pressure at the output 40b of the relay valve 40 can thus be targetedly controlled in open-loop and/or closed-loop fashion.

The parking brake device furthermore has a trailer valve line 61. The trailer valve line 61 is connected via the second branching point 41b to the control line 41.

Furthermore, in FIG. 1a, a trailer control valve 60 is arranged in the trailer valve line 61.

The trailer control valve 60 is configured as a 3/2 directional valve.

The trailer control valve 60 opens into a trailer control output 74. Via the trailer control output 74 of the parking brake device 1, it is thus possible for a control module of a trailer to be actuated in accordance with demand, in particular for the purposes of actuating the service brake of a trailer.

Furthermore, the trailer control valve 60 is connected to the spring brake line 51.

By means of the trailer control valve 60, it is possible for compressed air to be transferred or conducted from the trailer valve line 61 or from the spring brake line 51 to the trailer control output 74.

Furthermore, the trailer control valve 60 has a first control input 60a and a second control input 60b.

The first control input 60a is connected to the trailer valve line 61. The second control input 60b is connected to the spring brake line.

The trailer control valve 60 is switchable by virtue of different pressures prevailing at the first control port 60a and at the second control port 60b.

If a higher pressure prevails at the first control port 60a connected to the trailer valve line, the trailer control valve 60 is moved into a switching position such that the trailer control output 74 is connected to the trailer valve line 61.

If a higher pressure prevails at the second control port 60b connected to the spring brake line 51, the trailer control valve 60 is moved into a switching position such that the trailer control output 74 is connected to the spring brake line.

If identical or similar pressures prevail at the first control input 60a and at the second control input 60b, the trailer control valve 60 remains in the present switching position.

The mode of operation of the parking brake device 1 will be discussed below on the basis of FIGS 1a to 1f.

In a parked state (as illustrated in FIG. 1a), the inlet valve 21 is switched into an electrically deenergized open state. In the parked state as per FIG. 1a, the control valve 30 is switched into an electrically deenergized closed position. Compressed air can thus pass from the compressed-air port 10 to the control valve 30 into the control line 41.

By means of the control valve 30 switched into a closed position, the pressure along the control line 41 with the first branching point 41a and the control input 41c of the relay valve 40 is shut off in relation to the compressed-air port 10.

A connection between the spring brake line 51 and the trailer control output 74 is blocked by means of the trailer control valve 60.

In the parked state, the spring brake valve 50 is switched into an electrically deenergized open position. The feedback via the spring brake line 51 between the output 40b and the control input 40c is thus provided.

By virtue of the fact that, in the parked state, the pressure at the control input 40c of the relay valve 40 lies below a threshold pressure, the ventilation output 40d is open.

By means of the spring brake valve 50 switched into an open position, the control line 41 is ventilated along the first branching point 41a and the spring brake line 51 via the ventilation output 40d of the relay valve 40.

Likewise, the at least one spring-loaded brake cylinder output 71 and the service brake output 72 to a tractor vehicle of a motor vehicle are ventilated.

Thus, in the parked state, the at least one spring-loaded brake cylinder of the parking brake of the tractor vehicle is activated and imparts a braking force.

The trailer control valve 60 is switched into an open position in relation to the trailer valve line 61. A high pressure can thus be conducted from the compressed-air port 10 via the inlet valve 21, the second branching point 41b and the trailer control valve 60 to the trailer control output 74 of the parking brake device 1.

In this context, the trailer control output 74 is aerated in the parked state. A control module of the trailer can thus be correspondingly actuated.

In the situation as per FIG. 1a, in the parked state, the service brake of the trailer is released owing to the aerated trailer control output 74.

It is to be noted here that a service brake of the trailer is actuated inversely in relation to a service brake of the tractor vehicle.

In order to move from a parked state into a driving state, the control valve 30 is, in relation to the parked state as per FIG. 1a, switched into an open position, as shown in FIG. 1b. Compressed air can thus be conducted from the compressed-air port 10 via the inlet valve 21 and the control valve 30 to the first branching point 41a and to the control input 40c of the relay valve 40.

Furthermore, the spring brake valve 50 is switched into a closed position. A high pressure in the control line 30 thus cannot pass along the spring brake line 51 to the output 40b of the relay valve 40.

The compressed air that flows into the control line 41 via the inlet valve 21 is used for aerating the trailer valve line 61 and in particular the control input 40c of the relay valve 40.

The spring brake line 51 is ventilated and the trailer valve line 61 is aerated, such that, in FIG. 1b, the trailer control valve 60 produces a connection between the trailer control output 74 and the trailer valve line 61.

By virtue of the control input 40c of the relay valve 40 being supplied with a pressure which is higher than a threshold pressure, a connection is produced in the relay valve 40 between the input 40a and the output 40b.

When the threshold pressure is reached, the ventilation output 40d of the relay valve 40 is closed.

The pressure at the output or working output 40b is settable on the basis of the pressure in the control line 30 at the control input 40c. It is preferable for the pressure at the control input 40c and at the output or working output 40b of the relay valve 40 to be proportional.

A high pressure at the output 40b of the relay valve is conducted to the shuttle-type check valve 70. Following the higher pressure, the shuttle-type check valve 70 produces the connection to the spring-loaded brake cylinder output 71. The at least one spring-loaded brake cylinder of the tractor vehicle can be aerated.

In a next step as per FIG. 1c, as soon as the desired pressure is reached at the output 40b or the control input 40c of the relay valve 40, the control valve 30 is moved back into the electrically deenergized closed or shut-off state.

The spring brake valve 50 is switched into the electrically deenergized open state. A high pressure at the first branching point 41a and in the spring brake line 51 is thus confined between the control valve 30 and the relay valve 40.

As per FIG. 1c, in this next step, the inlet valve 21 is switched into a closed position.

The second branching point 41b with the trailer valve line 61 can be ventilated via the ventilation valve 22 switched into an open position.

The pressure difference between the ventilated trailer valve line 61 at the first control port 60a and the aerated spring brake line 51 at the second control port 60b leads to a switching of the trailer control valve 60.

The trailer control valve 60 provides a connection between the trailer control output 74 and the aerated spring brake line 51.

A combined braking action is available through the ventilation of the spring-loaded brake cylinder output 71 and of the trailer control output 74.

In the permanent driving state, as per FIG. 1d, the ventilation valve 22 is again switched into a closed position, and the inlet valve 21 is in turn switched into an open position. It is thus possible for compressed air to be held available as required, in particular in the control line up to the control valve 30 and the trailer valve line 61.

Both the first control input 60a and the second control input 60b are aerated. Owing to the lack of a pressure difference, the trailer control valve remains in the present switching position.

As per FIG. 1d, in the driving state, a connection is present between the spring brake line 51 and the trailer control output 74.

The trailer control output 74 and the spring-loaded brake cylinder output 71 are consequently aerated via the spring brake line 51.

This means that the service brake of the trailer and the parking brake of the tractor vehicle are released and do not impart any braking force. The driving state of the motor vehicle is thus enabled.

In general, the service brake output 72 of the service brake of a tractor vehicle can be ventilated via a further ventilation valve (not shown in FIGS. 1a to 1f). The service brake of the tractor vehicle is thus released in the driving state as per FIG. 1d. In particular, in the context of the present invention, the service brake of the tractor vehicle can be regarded as being active or activated only when it is directly actuated.

In order, as per FIG. 1e, to move from a driving state to a parked state, the spring brake valve 50 is moved into a closed position, such that the spring brake line 51 is shut off. The inlet valve 21 is likewise shut off.

The control valve 30 and the ventilation valve 22 are opened.

Ventilation of the control line 41, of the spring brake line 51 up to the spring brake valve 50 and of the trailer valve line 61 up to the trailer control valve 60 is performed via the ventilation valve 22.

Via the control line 41, the control input 40c of the relay valve 40 is also ventilated.

As soon as the pressure at the control input 40c of the relay valve falls below a threshold pressure, the connection between the input 40a and the output 40b is closed. At the same time, the connection between the output 40b and the ventilation output 40d of the relay valve is opened.

In this way, the output 40b of the relay valve connected to the trailer control output 74 and to the spring-loaded brake cylinder output 71 is ventilated.

The first control port 60a and the second control port 60b continue to have equal pressures owing to the ventilation via the ventilation valve 22 and the ventilation output 40d of the relay valve. The trailer control valve 60 remains, as per FIG. 1e, in the switching position for the connection of the spring brake line 51 to the trailer control output 74.

The at least one spring-loaded brake cylinder of the tractor vehicle is active as a parking brake again owing to the ventilated spring-loaded brake cylinder output 71.

Subsequently, the control valve 30 and the ventilation valve 22 are closed again for the parked state, as per FIG. 1a. The inlet valve 21 and the spring brake valve 50 are opened.

A switchover of the trailer control valve 60 for the parked state as per FIG. 1a is performed by virtue of the trailer valve line 61 being aerated via the inlet valve 21 and the spring brake line 51 being ventilated via the ventilation output 40d.

In FIG. 1a, the trailer control valve 60 produces a connection of the trailer control output 74 to the trailer valve line 61.

As a result, the trailer control output 74 is aerated. The spring-loaded brake cylinder output 71 and the service brake output 72 are ventilated.

Thus, in the parked state, the parking brake of the tractor vehicle in the form of the at least one spring-loaded brake cylinder is switched into an active state. The service brake of the trailer is released.

In order to move from the driving state (as per FIG. 1d) to a graduated braking state, a specific constant pressure or pressure range is set at the output 40b of the relay valve 40, as per FIG. 1f.

For this purpose, the spring brake valve 50 is switched into a closed position. The spring brake line 51 is thus shut off. The control valve 30 is switched into an open position.

Proceeding from the driving state, it is furthermore the case in FIG. 1f that the trailer control valve has been switched such that a connection is present between the spring brake line 51 and the trailer control output 74.

In the context of FIG. 1f, the inlet valve 21 and the ventilation valve 22 are switched into an open or shut-off position in order to respectively sufficiently aerate or ventilate the control input 40c of the relay valve 40 until a desired pressure is set at the output 40b of the relay valve 40.

Preferably, the inlet valve 21 and the ventilation valve 22 with the ventilation output 23 are switched into a partially open or flow-conducting position, in particular by means of multiple short successive actuations.

By means of the partially open switching position of the inlet valve 21 and of the ventilation valve 22, the switching position of the relay valve 40 can be regulated via the control input 40c.

By virtue of the fact that similar pressures continue to prevail at the first control port 60a and the second control port 60b of the trailer control valve 60 in relation to the driving state, no corresponding switching occurs.

Furthermore, by means of the at least partially open switching position of the inlet valve 21 and of the ventilation valve 22, a graduable braking action is possible through corresponding adaptation of the pressure at the control input 40c of the relay valve 40.

By means of the spring brake valve 50 switched into a closed position, a pressure set at the output 40b can be confined and held. Across the shuttle-type check valve 70, the spring-loaded brake cylinder output 71 is correspondingly aerated with the set pressure.

By virtue of the trailer control output 74 being connected to the spring brake line 51 via the trailer control valve 60, compressed air can be transferred from the output 40b of the relay valve 40 as per FIG. 1f both to the trailer control output 74 and to the spring-loaded brake cylinder output 71.

In a manner dependent on the pressure at the output 40c, a demand-dependent braking action is provided by the service brake of the trailer and the parking brake of the tractor vehicle, in the form of at least one spring-loaded brake cylinder.

Furthermore, it is also possible to implement a stretch-brake state with the first exemplary embodiment in the context of FIG. 1a to 1f, in particular proceeding from a driving state as per FIG. 1d. The switching into the operating state for the stretch-brake function is substantially based on the switching processes described above.

The spring-loaded brake cylinder output 71 is preferably aerated in the stretch-brake state.

The trailer control output 74 can be ventilated and aerated in accordance with demand, in particular by means of the trailer control valve 60.

The trailer control output 74 can thus expediently be aerated with compressed air, in particular in graduable fashion. A graduable braking action is available by means of the service brake of the trailer for the purposes of stretching and thereby stabilizing the motor vehicle.

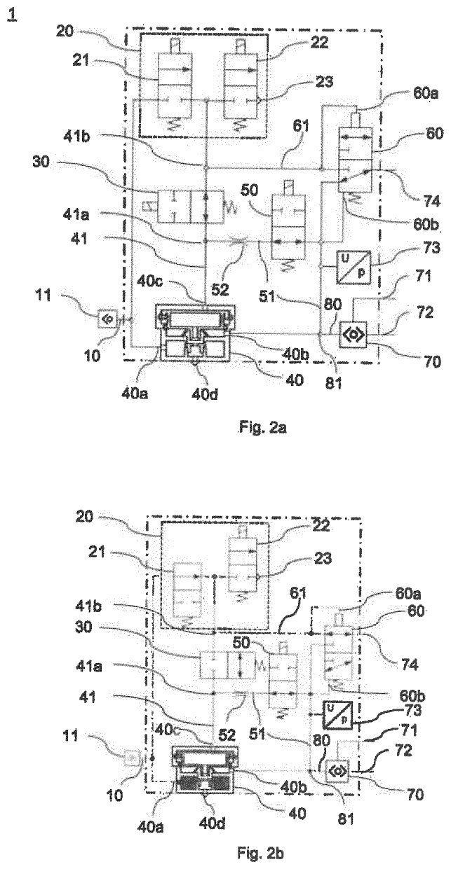

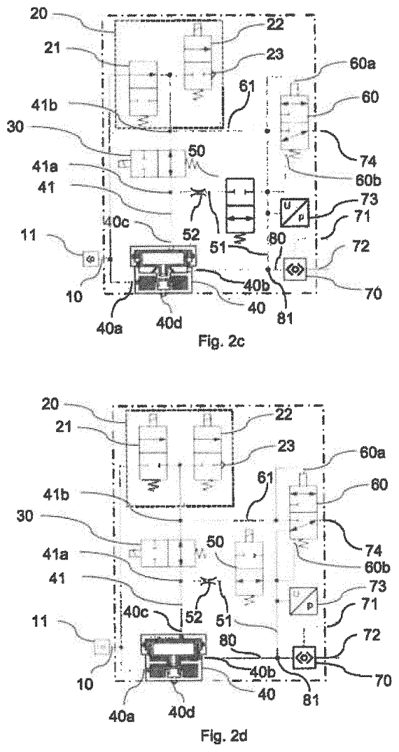

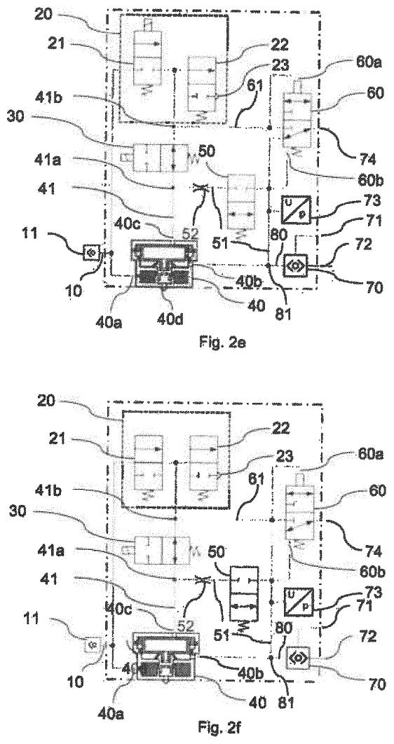

FIGS. 2a to 2f show, in a schematic illustration, a second exemplary embodiment of a parking brake device 1 for motor vehicles, in particular different switching states or operating states of the second exemplary embodiment.

The second exemplary embodiment differs, in FIG. 2a, from the embodiment as per FIG. 1a in a parked state in that the inlet valve 21 of the inlet ventilation solenoid valve unit 20 is switched into an electrically deenergized closed position. The control valve 30 is switched into an electrically deenergized open position. The trailer control valve 60 is switched such that there is a connection between the trailer control output 74 and the spring brake line 51.

Furthermore, in the parked state as shown in FIGS. 1a and 2a, the spring brake valve 50 is switched into an open or flow-conducting state.

Consequently, the trailer control output 74, the spring-loaded brake cylinder output 71 and the service brake output 72 are ventilated.

The at least one spring-loaded brake cylinder of the tractor vehicle is thus activated.

Likewise, the control module of a trailer is actuated or ventilated via the trailer control output 74 such that a service brake of the trailer is active.

In this context, the second exemplary embodiment as per FIG. 2b preferably has a further operating state, the trailer test state.

The trailer test state serves for the checking of the braking force of the at least one spring-loaded brake cylinder as parking brake in the event of failure of the braking function of the trailer that is normally active in the parked state in accordance with the second exemplary embodiment. This may be relevant in particular in the event of the motor vehicle being parked on a gradient.

To implement the trailer test state, proceeding from the parked state (as shown in FIG. 2a), the inlet valve 21 is switched into an open position as per FIG. 2b. The control valve 30 is switched into a closed position.

Compressed air can thus propagate from the compressed-air port 10 along the control line 41 to the second branching point 41b and the control valve 30 and along the trailer valve line 61.

The control input 40c of the relay valve 40 and the spring brake line 50 are cut off from the feed of compressed air from the compressed-air port 10 owing to the control valve 30 having been switched into a shut-off state.

The first control input 60a is ventilated in FIG. 2b, wherein the second control input 60b of the trailer valve unit 60 is ventilated. The trailer control valve 60 is thus switched such that there is a connection between the trailer valve line 61 and the trailer control output 74.

The trailer control output 74 is aerated. The trailer or the service brake of the trailer is released and does not impart any braking action.

By contrast, proceeding from the parked state, the spring-loaded brake cylinder output 71 remains ventilated, and the at least one spring-loaded brake cylinder of the tractor vehicle is activated.

In this way, the parking brake of the tractor vehicle, in the form of at least one spring-loaded brake cylinder at the ventilated spring-loaded brake cylinder output 71, can be checked for sufficient braking force.

Furthermore, in the context of the first exemplary embodiment as per FIGS. 2a to 2f, it is also possible for a stretch-brake state to be provided.

From a parked state into a driving state, the inlet valve 21 is switched into an open position as per FIG. 2c. The control valve 30 is switched into an open position. The spring brake valve 50 is switched into a closed position.

Compressed air can be conducted from the compressed-air port 10 to the control input 40c of the relay valve 40.

At the output 40b of the relay valve 40, a specific fluid pressure can be set, in a manner dependent on the pressure at the control input 40c, by means of the connection between input 40a and output 40b of the relay valve 40. The ventilation output 40d of the relay valve 40 is closed.

The pressure at the output 40b of the relay valve 40 is in turn conducted via the trailer control valve 60 to the trailer control output 74.

In particular, upon the transition from the parked state (as illustrated in FIG. 2a) into the driving state in the context of FIG. 2c, similar pressure conditions prevail at all times at the first control input 60a and at the second control input 60b, such that no switching of the trailer control valve 60 occurs.

The spring-loaded brake cylinder output 71 is aerated via the shuttle-type check valve 70 in accordance with the prevailing pressure gradient.

As soon as a desired pressure prevails at the control input 40c of the relay valve, the input valve 21 is switched into a shut-off position for the driving state as per FIG. 2d. The spring brake valve 50 is switched into an open or flow-conducting position for the driving state as per FIG. 2d.

As per FIG. 2d, in the driving state, there is thus feedback between output 40b and control input 40c of the relay valve 40 via the spring brake valve 50 and the restrictor unit 52 along the spring brake line 51.

A suitable driving state in the form of the aerated trailer control output 74, the aerated spring-loaded brake cylinder output 71 and the ventilated service brake output 72 is consequently attained.

In this context, the service brake of the trailer and the parking brake and the service brake of the tractor vehicle are released.

In order to move from the driving state into the parked state, the spring brake valve 50 is switched into a shut-off state as per FIG. 2e. The ventilation valve 22 is switched into an open or flow-conducting position.

By means of the control valve 30, which has already been switched into an open position, the control line 41 as per FIG. 2e up to the control input 40c of the relay valve 40 is ventilated via the ventilation valve 22 with the ventilation output 23.

A connection between the input 40a and the output 40b of the relay valve is shut off. The ventilation output 40d of the relay valve 40 is opened. Ventilation of the spring brake line 51 up to the spring brake valve 50, which has been switched into a shut-off state, occurs.

Likewise, the spring-loaded brake cylinder output 71 connected to the spring brake line 51, and the trailer control output 74, are ventilated via the ventilation output 40d.

Consequently, the at least one spring-loaded brake cylinder is activated, along with the service brake of the trailer.

For the parked state (as shown in FIG. 2a), the spring brake valve 50 is subsequently switched into a flow-conducting position. Likewise, the ventilation valve 22 is switched into a shut-off position.

In a further operating state, a graduated braking state as per FIG. 2f can be provided by means of a set constant pressure at the output 40b of the relay valve 40, preferably proceeding from the driving state as per FIG. 2d.

For this purpose, the control valve 30 is switched into an open position. The spring brake valve 50 is switched into a shut-off position. The feedback via the spring brake line 51 is thus eliminated.

The inlet valve 21 and the ventilation valve 22 are switched into a partially open position as required.

By means of the control valve 30 switched into an open position, a specific pressure can be applied to the control input 40c of the relay valve 40.

At the output 40b of the relay valve 40, the pressure is thus settable, in particular through corresponding control of the inlet valve 21 and of the ventilation valve 22 as per FIG. 2f.

In this context, at the output 40b of the relay valve 40, it is possible for a constant pressure to be held over a specific period of time and varied in graduated fashion.

The spring brake valve 50 switched into a closed position in this case prevents feedback between the output 40b and the control input 40c of the relay valve. In particular, a loss of air via the ventilation valve 22 is thus also prevented.

Owing to similar pressures at the first and second control inputs 60a, b, the trailer control valve 60 is in this case switched, as in the driving state, such that the trailer control output 74 is connected to the spring brake line 51.

Thus, the trailer control output 74 is aerated with the compressed air from the output 40b of the relay valve 40. Likewise, the spring-loaded brake cylinder output 71 is ventilated in accordance with the pressure gradient across the shuttle-type check valve 70.

A targeted partial braking action of the at least one spring-loaded brake cylinder of the tractor vehicle and of the service brake of the trailer can be set.

By virtue of the spring-loaded brake cylinder output 71 and the trailer control output 74 being aerated with intermittently constant pressures changed in graduated fashion, the braking action of the tractor vehicle and of the trailer can be varied in graduated fashion.

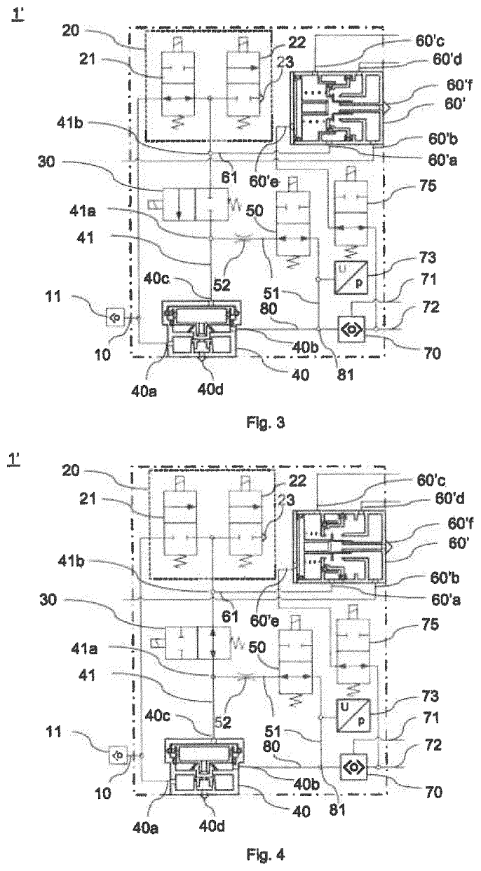

FIG. 3 shows, in a schematic illustration, a first exemplary embodiment of a parking brake device 1′ for motor vehicles with an integrated trailer control module.

The exemplary embodiment of a parking brake device 1′ as per FIG. 3 differs from the first exemplary embodiment as per FIGS. 1a to 1f in particular by the configuration of the trailer valve unit as an integrated trailer control module 60′.

The integrated trailer control module 60′ of the parking brake device 1′ has a control input 60′a, a supply input 60′b, a control output 60′c, a supply output 60′d, a feedback port 60′e and a ventilation output 60′f.

The control input 60′a of the trailer control module 60′ is connected to the trailer valve line 61. The supply input 60′b may be connected to an external compressed-air source or the like.

The control output 60′c and the supply output 60′d of the trailer control module 60′ lead via corresponding lines to the trailer or to the brake system of the trailer.

The parking brake device 1′ furthermore has a brake valve 75.

The brake valve 75, preferably a 2/2 directional valve, is switched into an open state when electrically deenergized.

The brake valve 75 is connected to the service brake output 72.

Furthermore, the feedback port 60′e of the trailer control module 60′ is connected to the brake valve 75.

There is feedback from the service brake output 72 via the brake valve 75 to the trailer control module 60′, in particular the feedback port 60′e.

A fluid pressure of the service brake port 72 can thus be conducted to the integrated trailer control module 60′ in order to impart a braking effect at the trailer.

In the event of actuation of the service brake of the tractor vehicle and in the presence of the resulting pressure at the service brake output 72, a combined braking action is thus available via the feedback port 60′e.

As is likewise shown in FIG. 1a, the inlet valve 21, in the parked state as per FIG. 3, is switched into an electrically deenergized open position, and the control valve 30 is switched into an electrically deenergized shut-off position.

The switching between the operating states is performed by means of the parking brake device 1′ as per FIG. 3 in a similar manner to that already described with regard to FIGS. 1a to 1f.

By contrast, the actuation of the trailer control module 60′ is performed by means of the feedback port 60′e connected to the service brake output 72 and by means of the trailer valve line 61 via the second branching point 41b of the control line 41.

For this purpose, feedback of the air pressure from the service brake output 72 to the feedback port 60′e can be prevented as required by switching of the brake valve 75 into a shut-off or closed state.

FIG. 4 shows, in a schematic illustration, a second exemplary embodiment of a parking brake device 1′ for motor vehicles with an integrated trailer control module.

The exemplary embodiment of a parking brake device 1′ as per FIG. 4 differs from the second exemplary embodiment as per FIGS. 2a to 2f in particular by the configuration of the trailer valve unit as an integrated trailer control module 60′.

The trailer control module 60′ is in this case provided in the same form as described with regard to FIG. 3.

Furthermore, like the exemplary embodiment as per FIG. 3, the exemplary embodiment of the parking brake device 1′ as per FIG. 4 has the brake valve 75.

A connection which provides feedback is thus provided between the feedback port 60′e and the service brake port 72 as per FIG. 4.

As per FIG. 4, the inlet valve 21 is switched into an electrically deenergized shut-off state and the control valve 30 is switched into an electrically deenergized open state, as already shown in FIG. 2.

For the exemplary embodiment as per FIG. 4, switching between the operating states is performed in a similar manner to that described with regard to FIGS. 2a to 2f.

Thus, aside from a parked state, a driving state and a graduated braking state, a trailer test state is also provided for the embodiment as per FIG. 4. In this way, it is possible to ensure a sufficient braking action of the tractor vehicle for the situation that the brake device of the trailer could fail in a parked state on a gradient.

In general, in the context of the present invention, advantageous switching between the operating states can thus be attained by means of the restrictor unit 52 and in particular by means of the spring brake valve 50 by virtue of the fact that the spring brake line 51, which provides feedback, can be shut off as required.

### LIST OF REFERENCE DESIGNATIONS

1 Parking brake device

10 Compressed-air port

11 Check valve

20 Inlet ventilation solenoid valve unit

21 Inlet valve

22 Ventilation valve

23 Ventilation output

30 Control valve

40 Relay valve

40a Input

40b Output

40c Control input

40d Ventilation output

41 Control line

41a First branching point

41b Second branching point

50 Spring brake valve

51 Spring brake line

52 Restrictor unit

60 Trailer valve unit; trailer control valve

60′ Trailer valve unit; trailer control module

60′a Control input

60′b Supply input

60′c Control output

60′d Supply output

60′e Feedback port

60′f Ventilation output

61 Trailer valve line

70 Shuttle-type check valve

71 Spring-loaded brake cylinder output

72 Service brake output

73 Compressed-air sensor

74 Trailer control output

85 Brake valve

80 First output line

81 Output branching point

1.-13. (canceled)

14. A parking brake device for motor vehicles, comprising:
at least one compressed-air port;
an inlet ventilation solenoid valve unit;
a relay valve; and
at least one first compressed-air output,
wherein the compressed-air port is connected to the inlet ventilation solenoid valve unit and to the relay valve,
wherein a control line is provided such that the relay valve is connected or connectable to the inlet ventilation solenoid valve unit,
wherein the control line has a first branching point and a second branching point upstream of the relay valve, and
wherein an output line is provided which is connected to the at least one first compressed-air output and which has an output branching point,
wherein a control valve is arranged between the first branching point and the second branching point of the control line.

15. The parking brake device as claimed in claim 14, wherein
a spring brake line is provided which is connected via the first branching point to the control line and via the output branching point to the output line.

16. The parking brake device as claimed in claim 15, wherein
a trailer valve line is provided which is connected via the second branching point to the control line.

17. The parking brake device as claimed in claim 15, wherein
the parking brake device has a spring brake valve which is arranged in the spring brake line and is connected to the relay valve.

18. The parking brake device as claimed in claim 17, wherein
a restrictor unit is arranged in the spring brake line between the output branching point of the output line and the first branching point of the control line.

19. The parking brake device as claimed in claim 18, wherein
the spring brake line via the restrictor unit and the spring brake valve forms a feedback connection to the relay valve.

20. The parking brake device as claimed in claim 18, wherein
the spring brake valve is provided as a solenoid valve which is open when electrically deenergized, such that, in the electrically deenergized state of the spring brake valve, between a control input and an output of the relay valve, there is feedback via the control line, the spring brake line and the output line with the spring brake valve and the restrictor unit.

21. The parking brake device as claimed in claim 14, wherein
an inlet valve of the inlet ventilation solenoid valve unit is provided as a solenoid valve which is open when electrically deenergized, and the control valve is provided as a solenoid valve which is closed when electrically deenergized.

22. The parking brake device as claimed in claim 15, wherein
the inlet valve of the inlet ventilation solenoid valve unit is provided as a solenoid valve which is closed when electrically deenergized, and
the control valve is provided as a solenoid valve which is open when electrically deenergized.

23. The parking brake device as claimed in claim 16, wherein
the parking brake device has a trailer valve unit which is connected to the inlet ventilation solenoid valve unit via the trailer valve line, the second branching point and the control line.

24. The parking brake device as claimed in claim 23, wherein
the trailer valve unit is a trailer control valve which is connected to the spring brake line and via the spring brake line to the spring brake valve and the relay valve.

25. The parking brake device as claimed in claim 23, wherein
the trailer valve unit is formed as a trailer control module which is integrated into the parking brake device.

26. The parking brake device as claimed in claim 14, wherein
the inlet ventilation solenoid valve unit is designed such that at least one inlet valve is provided between the compressed-air port and the control line, and a ventilation valve is provided between the control line and a ventilation output.
